(19) United States
(12) Patent Application Publication
(10) Pub. No.: US 2024/0241424 A1
(43) Pub. Date: Jul. 18, 2024

(54) PHOTONIC INTEGRATED CIRCUIT STRUCTURE

(71) Applicant: CLOUD LIGHT TECHNOLOGY LIMITED, Hong Kong (HK)

(72) Inventors: CHANG-HUNG TIEN, New Taipei City (TW); MING-HSING CHUNG, New Taipei City (TW); TING-JHANG LIAO, Hong Kong (HK); BO-HONG MA, New Taipei City (TW)

(21) Appl. No.: 18/133,546

(22) Filed: Apr. 12, 2023

(30) Foreign Application Priority Data
Jan. 16, 2023 (TW) 112200531

(51) Int. Cl. G02F 1/225; G02F 1/21

(52) U.S. Cl. CPC G02F 1/2255; G02F 1/212

(57) ABSTRACT

A photonic integrated circuit structure comprises a first photonic chip module, having a first upper side and a first lower side substantially parallel to the first upper side; a second photonic chip module, having a second upper side and a second lower side substantially parallel to the second upper side, the second upper side integrally connected to the first lower side; and a predetermined cropping area, located between the second upper side and the first lower side, configured to be a reference when block cropping is performed. The photonic integrated circuit structure may be applied to photonic chip usage specifications of 4-channel transmission or 8-channel transmission.

### CROSS-REFERENCE TO RELATED APPLICATION

This non-provisional application claims priority under 35 U.S.C. § 119(a) on Patent Application No(s). 112200531 filed in Taiwan, R.O.C. on Jan. 16, 2023, the entire contents of which are hereby incorporated by reference.

### BACKGROUND OF THE INVENTION

### 1. Field of the Invention

The present disclosure relates to an integrated circuit structure, and in particular to a photonic integrated circuit structure.

### 2. Description of the Related Art

Accompanied with the development of communication technology and Internet of Things (IoT) technology, various electronic products are capable of providing users with notifications and performing automated operations or remote control through the Internet. Thus, people also demand increasingly demanding requirements on communication technology, in terms of high transmission speed, large transmission data amount, and low latency time.

In a photonic integrated circuit (PIC), a photonic element is integrated on a chip by using semiconductor manufacturing technology, and “light” is used as signals to transmit digital data, hence implementing functions including high-speed photoelectric conversion, transmission, and signal processing. Such photonic integrated circuit further features advantages of having reduced module sizes and lowered power consumption, and has an application range covering fields of optical communications, photosensitive systems, and intelligent Internet of Things. During manufacturing of photonic integrated circuits, specifications differ in terms of 4-channel and 8-channel communications according to usage requirements on transmission speed and data transmission amount. In general, for the ease of assembly space and manufacturing, photonic integrated circuits are manufactured separately according to two (that is, 4-channel and 8-channel) layouts.

### BRIEF SUMMARY OF THE INVENTION

For the separate manufacturing above, two photonic integrated circuit specifications need to be designed and developed, and this is extremely costly and time consuming in aspects of research and development cost. For example, due to a relationship between limited element size and configuration space, an optical signal input terminal and an optical signal output terminal of a 4-channel photonic integrated circuit are configured on different sides. However, due to design requirements, an optical signal input terminal and an optical signal output terminal of a 8-channel photonic integrated circuit are configured on the same side.

In view of the above prior art, the present invention provides a photonic integrated circuit structure with design sharing, hence significantly reducing development time and cost of photonic integrated circuits.

To achieve the above and other objects, the present disclosure provides a photonic integrated circuit structure, including: a first photonic chip module, having a first upper side and a first lower side substantially parallel to the first upper side; a second photonic chip module, having a second upper side and a second lower side substantially parallel to the second upper side, the second upper side integrally connected to the first lower side; and a predetermined cropping area, located between the second upper side and the first lower side, configured to be a reference when block cropping is performed. Thus, the photonic integrated circuit structure of the present disclosure may be flexibly applied to photonic chip usage specifications of 4-channel transmission or 8-channel transmission, as well as improving the issue of high research and development cost of photonic integrated circuits.

In an embodiment, the predetermined cropping area is substantially parallel to the second upper side or the first lower side.

In an embodiment, a plurality of first direct-current (DC) power control contacts are provided near the first upper side, a plurality of second DC power control contacts are provided near the first lower side, a plurality of third DC power control contacts are provided near the second upper side, and a plurality of fourth DC power control contacts are provided near the second lower side.

In an embodiment, the predetermined cropping area is located between the plurality of second DC power control contacts and the plurality of third DC power control contacts.

In an embodiment, each contact of the plurality of second DC power control contacts and each contact of the plurality of third DC power control contacts are one-on-one electrically coupled.

In an embodiment, the first photonic chip module further has a first left side and a first right side substantially parallel to the first left side, and the second photonic chip module further has a second left side and a second right side substantially parallel to the second left side.

In an embodiment, a plurality of first optical signal input terminals and a plurality of first optical signal output terminals are provided on the first left side, a plurality of second optical signal input terminals and a plurality of second optical signal output terminals are provided on the second left side, a plurality of first radio-frequency (RF) signal control contacts are provided on the first right side, and a plurality of second RF signal control contacts are provided on the second right side.

In an embodiment, the first photonic chip module further has a plurality of first modulators, which are respectively connected to the plurality of first optical signal input terminals, the plurality of first optical signal output terminals, and the plurality of first RF signal control contacts. The second photonic chip module further has a plurality of second modulators, which are respectively connected to the plurality of second optical signal input terminals, the plurality of second optical signal output terminals, and the plurality of second RF signal control contacts.

In an embodiment, the plurality of first modulators and the plurality of second modulators are Mach Zehnder modulators (MZM).

Thus, the photonic integrated circuit structure of the present disclosure is configured with a plurality of DC power control contacts on both upper and lower sides of each photonic chip module, allowing each photonic chip module to use the same printed circuit board (PCB) layout when used individually. A plurality of RF signal control contacts is provided on the right side of each photonic chip module. Since the position of each RF signal control contact is fixed, during wire bonding of a printed circuit board, the positions or lengths of wire bonding do not need to be correspondingly changed in response to the 4-channel transmission specification or the 8-channel transmission specification, hence reducing manufacturing cost and assembly difficulties. Moreover, the photonic integrated circuit structure of the present disclosure adopts design sharing, hence significantly reducing development time and cost of photonic integrated circuits.

### BRIEF DESCRIPTION OF THE DRAWINGS

FIG. 1 is a structural schematic diagram of a photonic integrated circuit having an 8-channel transmission specification according to an embodiment of the present disclosure.

FIG. 2 is a structural schematic diagram of a photonic integrated circuit having a 4-channel transmission specification according to an embodiment of the present disclosure.

### DETAILED DESCRIPTION OF THE INVENTION

To facilitate understanding of the object, characteristics, and effects of this present disclosure, embodiments together with the attached drawings for the detailed description of the present disclosure are provided.

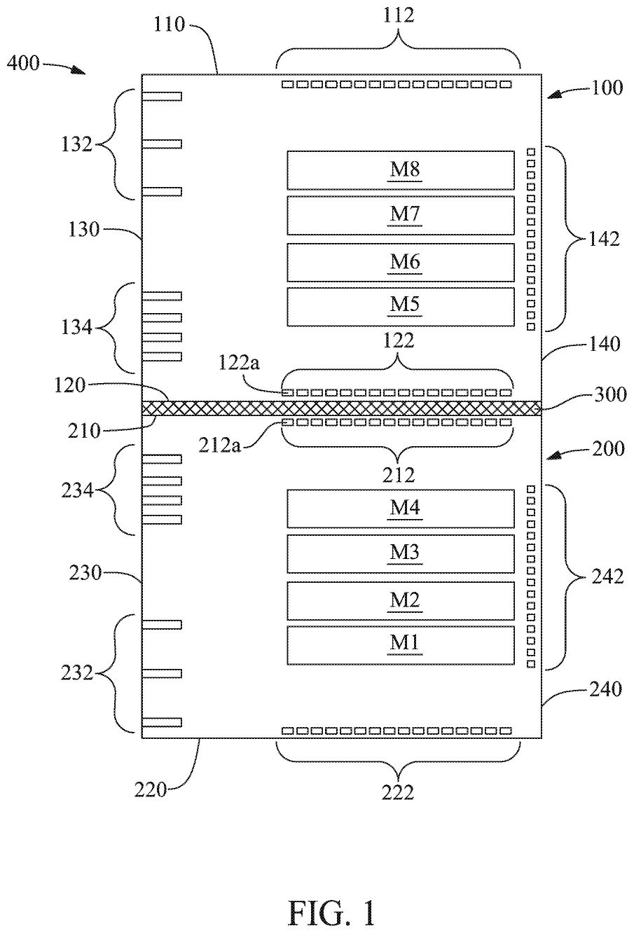

Refer to FIG. 1 showing a structural schematic diagram of a photonic integrated circuit having an 8-channel transmission specification according to an embodiment of the present disclosure. As shown in FIG. 1, the photonic integrated circuit structure 400 includes a first photonic chip module 100, a second photonic chip module 200, and a predetermined cropping area 300.

The first photonic chip module 100 has a first upper side 110 and a first lower side 120 substantially parallel to the first upper side 110. A plurality of first direct-current (DC) power control contacts 112 are provided near the first upper side 110, and a plurality of second DC power control contacts 122 are provided near the first lower side 120.

The first photonic chip module 100 further has a first left side 130 and a first right side 140 substantially parallel to the first left side 130. One end of the first left side 130 is connected to one end of the first upper side 110, and the first left side 130 is substantially perpendicular to the first upper side 110. Moreover, another end of the first left side 130 is connected to one end of the first lower side 120. One end of the first right side 140 is connected to another end of the first upper side 110, and the first right side 140 is substantially perpendicular to the first upper side 110. Moreover, another end of the first right side 140 is connected to another end of the first lower side 120. A plurality of first optical signal input terminals 132 and a plurality of first optical signal output terminals 134 are provided on the first left side 130. The first optical signal input terminals 132 are configured to receive optical signals, and the first optical signal output terminals 134 are configured to output optical signals. A plurality of first radio-frequency (RF) signal control contacts 142 are provided on the first right side 140. The first RF signal control contacts 142 are configured to be coupled to a printed circuit board (PCB, not shown).

The first photonic chip module 100 further has a plurality of first modulators (that is, a fifth modulation unit M5, a sixth modulation unit M6, a seventh modulation unit M7, and an eighth modulation unit M8). The plurality of first modulators comprises, for example, Mach Zehnder modulators (MZM). Each of the fifth modulation unit M5, the sixth modulation unit M6, the seventh modulation unit M7, and the eighth modulation unit M8 is connected to the plurality of first optical signal input terminals 132, the plurality of first optical signal output terminals 134, and the plurality of first RF signal control contacts 142. More specifically, each of one end of the fifth modulation unit M5 and one end of the sixth modulation unit M6 is connected to the first optical signal input terminals 132 via the first RF signal control contacts 142. Each of another end of the fifth modulation unit M5 and another end of the sixth modulation unit M6 is connected to the first optical signal output terminals 134. Each of one end of the seventh modulation unit M7 and one end of the eighth modulation unit M8 is connected to the first optical signal input terminals 132 via the first RF signal control contacts 142. Each of another end of the seventh modulation unit M7 and another end of the eighth modulation unit M8 is connected to the first optical signal output terminals 134. The first modulators are configured to modulate an electrical signal into an optical signal to generate amplitude modulation (AM), phase modulation (PM), and/or polarization modulation of the optical signal. In some embodiments, a number of the first modulators may be increased or decreased according to design requirements.

Since the first modulators are located on positions between the first optical signal input terminals 132, the first optical signal output terminals 134, and the first RF signal control contacts 142 and are close to a center of the first photonic chip module 100, positions or lengths of wire bonding do not have to be correspondingly changed in response to a 4-channel transmission specification or an 8-channel transmission specification during wire bonding of the printed circuit board. In other words, the first photonic chip module 100 and the second photonic chip module 200 have the same and fixed wire bonding means and positions, hence providing simplified manufacturing processes and reducing manufacturing difficulties.

The second photonic chip module 200 is integrally connected to the first photonic chip module 100. The second photonic chip module 200 and the first photonic chip module 100 form the photonic integrated circuit structure 400 having an 8-channel transmission specification in terms of usage functions. The second photonic chip module 200 has a second upper side 210 and a second lower side 220 substantially parallel to the second upper side 210. The second upper side 210 is integrally connected to the first lower side 120. The second photonic chip module 200 further has a second left side 230 and a second right side 240 substantially parallel to the second left side 230. A plurality of third DC power control contacts 212 are provided near the second upper side 210, and a plurality of fourth DC power control contacts 222 are provided near the second lower side 220. In an embodiment, each contact of the plurality of second DC power control contacts 122 and each contact of the plurality of third DC power control contacts 212 are one-to-one electrically coupled. For example, a contact 122a is electrically coupled to a contact 212a, a contact on the right of the contact 122a is electrically coupled to a contact on the right of the contact 212a, and so forth, hence forming the one-to-one electrical coupling relationship of the contacts.

The second photonic chip module 200 further has a second left side 230 and a second right side 240 substantially parallel to the second left side 230. One end of the second left side 230 is connected to one end of the second upper side 210, and the second left side 230 is substantially perpendicular to the second upper side 210. Moreover, another end of the second left side 230 is connected to one end of the second lower side 220. One end of the second right side 240 is connected to another end of the second upper side 210, and the second right side 240 is substantially perpendicular to the second upper side 210. Moreover, another end of the second right side 240 is connected to another end of the second lower side 220. A plurality of second optical signal input terminals 232 and a plurality of second optical signal output terminals 234 are provided on the second left side 230. The second optical signal input terminals 232 are configured to receive optical signals, and the second optical signal output terminals 234 are configured to output optical signals. A plurality of second RF signal control contacts 242 are provided on the second right side 240. The second RF signal control contacts 242 are configured to be coupled to a printed circuit board (not shown).

The second photonic chip module 200 further has a plurality of second modulators (that is, a first modulation unit M1, a second modulation unit M2, a third modulation unit M3, and a fourth modulation unit M4). The plurality of second modulators comprises, for example, Mach Zehnder modulators (MZM). Each of the first modulation unit M1, the second modulation unit M2, the third modulation unit M3, and the fourth modulation unit M4 is connected to the plurality of second optical signal input terminals 232, the plurality of second optical output terminals 234, and the plurality of second RF signal control contacts 242. More specifically, each of one end of the first modulation unit M1 and one end of the second modulation unit M2 is connected to the second optical signal input terminals 232 via the second RF signal control contacts 242. Each of another end of the first modulation unit M1 and another end of the second modulation unit M2 is connected to the second optical signal output terminals 234. Each of one end of the third modulation unit M3 and one end of the fourth modulation unit M4 is connected to the second optical signal input terminals 232 via the second RF signal control contacts 242. Each of another end of the third modulation unit M3 and another end of the fourth modulation unit M4 is connected to the second optical signal output terminals 234. The second modulators are configured to modulate an electrical signal into an optical signal to generate amplitude modulation, phase modulation, and/or polarization modulation in the optical signal. In some embodiments, a number of the second modulators may be increased or decreased according to design requirements. For the consideration of simplified manufacturing process, the number of the second modulators should be designed to be equal to the number of the first modulators.

Since the second modulators are located on positions between the second optical signal input terminals 232, the second optical signal output terminals 234, and the second RF signal control contacts 442 and are close to a center of the second photonic chip module 200, the positions or lengths of wire bonding do not to be correspondingly changed in response to a 4-channel transmission specification or an 8-channel transmission specification during wire bonding of the printed circuit board. In other words, the first photonic chip module 100 and the second photonic chip module 200 have the same and fixed wire bonding means and positions, hence providing simplified manufacturing processes and reducing manufacturing difficulties.

Moreover, the first optical signal input terminals 132 and the second optical signal input terminals 232 form a mirror position structure, and the first optical signal output terminals 134 and the second optical signal output terminals 234 form a mirror position structure. With the above position structures, optical signals of all channels can be transmitted by using merely one set of optical elements. In some embodiments, the first optical signal input terminals 132 and the second optical signal input terminals 232 may also be configured to form a non-mirror position structure. Similarly, the first optical signal output terminals 134 and the second optical signal output terminals 234 may also be configured to form a non-mirror position structure.

The predetermined cropping area 300 is located between the second upper side 210 and the first lower side 120. The predetermined cropping area 300 is configured to serve as a reference when block cropping is performed. The predetermined cropping area 300 is substantially parallel to the second upper side 210 or the first lower side 120. The block cropping may be performed by first inscribing a cropping notch in the predetermined cropping area 300 using a laser, and then cutting along the cropping notch using a blade wheel. In some embodiments, the block cropping may be cutting along the predetermined cropping area using a laser so as to separate the first photonic chip module 100 and the second photonic chip module 200. In some embodiments, the block cropping may be performed by cutting along the predetermined cropping area using a blade wheel so as to separate the first photonic chip module 100 and the second photonic chip module 200. The means of block cropping above are merely examples and are not to be construed as limitations. In some embodiments, the predetermined cropping area 300 may be marked by a color. In some embodiments, the predetermined cropping area 300 may be not marked at all. In some embodiments, the predetermined cropping area 300 may be defined by an area between the second DC power control contacts 122 and the third DC power control contacts 212.

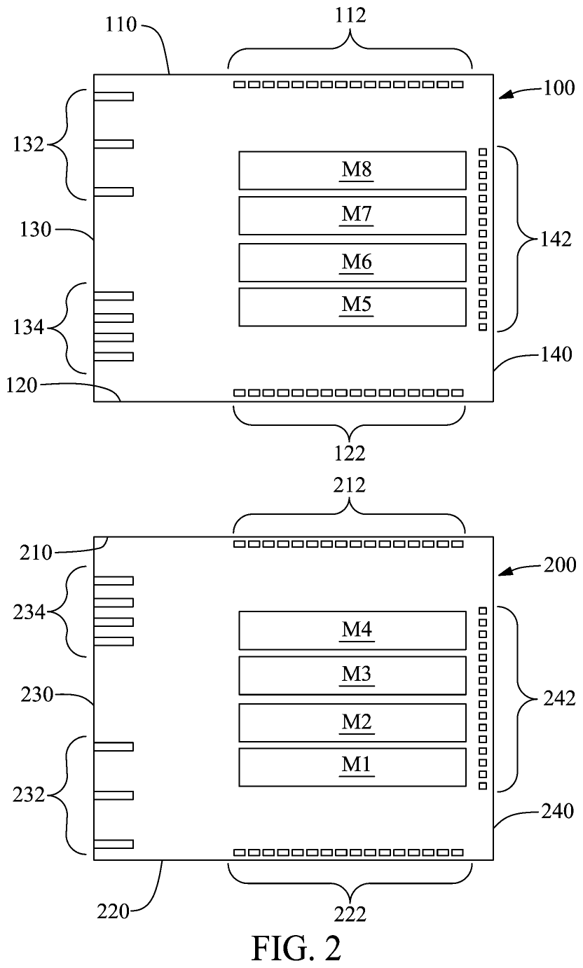

Refer to FIG. 2 showing a structural schematic diagram of a photonic integrated circuit having a 4-channel transmission specification according to an embodiment of the present disclosure. As shown in FIG. 2, after the block cropping, the photonic integrated circuit structure 400 is separated into the first photonic chip module 100 having a 4-channel specification and the second photonic chip module 200 having a 4-channel specification. Thus, a plurality of DC power control contacts are configured on both the upper and lower sides of the first photonic chip module 100, allowing the first photonic chip module 100 to use the same printed circuit board layout when used individually for the 4-channel specification, hence improving ease of assembly. Similarly, a plurality of DC power control contacts are configured on both the upper and lower sides of the second photonic chip module 200, allowing the second photonic chip module 200 to use the same printed circuit board layout when used individually for the 4-channel specification, hence improving the ease of assembly. In other words, in the aspect of photonic integrated circuit design, research and development for only the 4-channel specification, but not the additional research and development for only the 8-channel specification, needs to be carried out, hence shortening the research and development time for faster production.

In conclusion, the photonic integrated circuit structure of the present disclosure is configured with a plurality of DC power control contacts on both upper and lower sides of each photonic chip module, allowing each photonic chip module to use the same printed circuit board layout when used individually. A plurality of RF signal control contacts is provided on the right side of each photonic chip module. Since the position of each RF signal control contact is fixed, during wire bonding of a printed circuit board, the positions or lengths of wire bonding do not need to be correspondingly changed in response to the 4-channel transmission specification or the 8-channel transmission specification, hence reducing manufacturing cost and assembly difficulties. Moreover, the photonic integrated circuit structure of the present disclosure adopts design sharing, hence significantly reducing development time and cost of photonic integrated circuits.

The present invention is described by way of the preferred embodiments above. A person skilled in the art should understand that, these embodiments are merely for describing the present invention are not to be construed as limitations to the scope of the present invention. It should be noted that all equivalent changes, replacements and substitutions made to the embodiments are to be encompassed within the scope of the present invention. Therefore, the scope of protection of the present invention should be accorded with the broadest interpretation of the appended claims.

What is claimed is:

1. A photonic integrated circuit structure, comprising:
a first photonic chip module having a first upper side and a first lower side substantially parallel to the first upper side;
a second photonic chip module having a second upper side and a second lower side substantially parallel to the second upper side, wherein the second upper side is integrally connected to the first lower side; and
a predetermined cropping area configured to serve as a reference when block cropping is performed.

2. The photonic integrated circuit structure according to claim 1, wherein the predetermined cropping area is substantially parallel to the second upper side or the first lower side.

3. The photonic integrated circuit structure according to claim 1, wherein a plurality of first direct-current (DC) power control contacts are provided near the first upper side, a plurality of second DC power control contacts are provided near the first lower side, a plurality of third DC power control contacts are provided near the second upper side, and a plurality of fourth DC power control contacts are provided near the second lower side.

4. The photonic integrated circuit structure according to claim 3, wherein the predetermined cropping area is located between the plurality of second DC power control contacts and the plurality of third DC power control contacts.

5. The photonic integrated circuit structure according to claim 3, wherein each contact of the plurality of second DC power control contacts and each contact of the plurality of third DC power control contacts are one-to-one electrically coupled.

6. The photonic integrated circuit structure according to claim 1, wherein the first photonic chip module further has a first left side and a first right side substantially parallel to the first left side, and the second photonic chip module further has a second left side and a second right side substantially parallel to the second left side.

7. The photonic integrated circuit structure according to claim 6, wherein a plurality of first optical signal input terminals and a plurality of first optical signal output terminals are provided on the first left side, a plurality of second optical signal input terminals and a plurality of second optical signal output terminals are provided on the second left side, a plurality of first radio-frequency (RF) signal control contacts are provided on the first right side, and a plurality of second RF signal control contacts are provided on the second right side.

8. The photonic integrated circuit structure according to claim 7, wherein the first photonic chip module further has a plurality of first modulators, which are respectively connected to the plurality of first optical signal input terminals, the plurality of first optical signal output terminals, and the plurality of first RF signal control contacts; the second photonic chip module further has a plurality of second modulators, which are respectively connected to the plurality of second optical signal input terminals, the plurality of second optical signal output terminals, and the plurality of second RF signal control contacts.

9. The photonic integrated circuit structure according to claim 8, wherein the plurality of first modulators and the plurality of second modulators are Mach Zehnder modulators (MZM).
